(19) United States
(12) Patent Application Publication
(10) Pub. No.: US 2020/0113138 A1
(43) Pub. Date: Apr. 16, 2020

(54) PLANT CULTURE PROPAGATION AND GERMINATION APPARATUS

(71) Applicants: Daniel Torres, Glendale, CA (US); Jeffrey Malinovitz, Woodland Hills, CA (US)

(72) Inventors: Daniel Torres, Glendale, CA (US); Jeffrey Malinovitz, Woodland Hills, CA (US)

(21) Appl. No.: 16/597,777

(22) Filed: Oct. 9, 2019

Related U.S. Application Data
(63) Continuation-in-part of application No. 14/943,864, filed on Nov. 17, 2015, now abandoned.
(60) Provisional application No. 62/084,473, filed on Nov. 25, 2014.

(51) Int. Cl. A01G 9/24; A01G 9/26; A01G 9/14

(52) U.S. Cl. CPC A01G 9/247; A01G 9/14; A01G 9/26

(57) ABSTRACT

A growing device for propagation and germination of plants, the device having a transparent dome positioned over a transparent propagation tray contained within an opaque catch tray and a locking mechanism for rigidly connecting the transparent dome with both the transparent propagation tray and the catch tray.

### CROSS-REFERENCE TO RELATED APPLICATION(S)

This application claims the benefit of and priority to U.S. Provisional Application No. 62/084,473, filed 25 Nov. 2014, and patent application Ser. No. 14/943,864, filed 17 Nov. 2015, of which this application is a continuation-in-part, the entire contents of both of which are incorporated herein by reference.

### FIELD OF THE INVENTION

The present invention relates generally to germination and propagation devices and more particularly an apparatus having a transparent propagation tray.

### BACKGROUND ON THE INVENTION

Plant propagation can better be defined as the process of creating new plants from a variety of sources, mainly seeds, cuttings, bulbs, or other plant parts. Success for plant propagation depends upon the successful formation of roots from the seeds or clone cuttings. The ability to detect when the seed or cutting actually produces roots is paramount. Plant propagation through seeds and cuttings is typically done in a tray and to check on root growth, the growing medium is manually lifted to check for the roots. Manually lifting the growing medium to check for root growth can have the negative effect of damaging tender or beginning roots as well as giving false readings as to how well the seeds are sprouting roots throughout the entire tray. A thorough checking would require moving the medium through multiple locations throughout the tray which compounds the problem.

Considering seed germination requires a dark environment, utilizing transparent trays deters root growth. Considering large scale plant propagation through seeds or cuttings requires root growth monitoring to be efficient so that only the proper length of time expires before seedlings are transferred from propagation trays to pots or other growing containers, it is important to be able to monitor root growth on a continual basis without disturbing the growing medium.

### SUMMARY OF EMBODIMENTS OF THE INVENTION

The present concept provides an apparatus having the capability of enabling the grower to quickly and continually monitor root growth without disturbing the growing medium. Thus, the apparatus has a transparent propagation tray which addresses the problems associated with prior germination devices. The device comprises three components, a transparent dome which can regulate humidity within the dome, a transparent internal propagation tray having grooves to allow water to channel out through a plurality of drain holes, and an opaque catch tray adapted to contain the transparent internal propagation tray so that there is no light penetration to damage or prevent the roots from growing. The transparent internal propagation tray and the opaque catch tray sit flush with one another without a significant difference in height between the two different surfaces and provide no obstruction or interference between them.

The transparent dome includes at least one and preferably two ventilation sites to regulate airflow to reduce moisture loss to seedlings and plant cuttings. The dome includes a locking mechanism to alleviate any damage during transporting the device and prevent damage to plants as a result of the dome coming apart from the trays. Previously domes of this general type were attached to a tray using adhesive masking or packing tape or other inefficient methods. An internal locking feature eliminates unwanted adhesive residue and properly secures the components from unwanted separation.

Alternatively, the dome can also be fitted with an integral thermometer and hygrometer which could include a digital display that enables a user to monitor and determine both the adequate temperature and humidity levels for optimal growth within the device. Having an internal thermometer and hygrometer eliminates removal of the dome and the use of external temperature and humidity probes.

The second component of the device is the propagation tray itself which is a durable transparent tray which allows water to pass through small drain holes located at the bottom of the tray and into the catch tray. The transparent tray includes grooves to allow for water to channel out through the drainage holes. The transparent internal propagation tray facilitates the observation of root protrusion by simply lifting the tray out of the catch tray and looking at the clear underside of the tray. With the naked eye, in a brief moment and without the need to disturb the growing medium, root growth can be observed from the seedlings and cuttings. This observation allows the user to determine when the seedlings are ready to be transferred to the next larger container. Growing medium is positioned in the propagation tray and can be a substance through which roots grow and extract water and nutrients. Rockwool or mineral wool, which are inorganic fiber substances that are produced by steam-blasting and cooling molten glass, or a similar substance, is used as an insulator and filtering material. The roots that grow through this material then protrude through and out the rockwool at which point the material is taken from the trays and transplanted into larger containers for more developmental growth.

The third component of the propagation apparatus is the catch tray which is made from a durable completely opaque polymer, preferably black in color, to prevent any light from sun or lamps from coming into contact with the growing medium from the underside of the transparent tray. If roots are exposed to light for other than a very brief period of time, they cease to grow, withering, and eventually dying. Thus, the catch tray encloses the transparent tray and serves as a housing unit as the transparent tray fits snugly inside of the catch tray. The dimensions of the catch tray effectively coincide with the dimensions of the transparent tray so that they fit snuggly together.

As an option, the catch tray can include a detachable heating pad incorporated within the exterior grooves of the catch tray. The heating element can be insulated rubber-covered coils. A digital temperature control gauge is attached to the power cord of the heating element. In plant propagation, heating is an important element for root development and root growth. Heat can provide an environment which, in some circumstances, may be necessary in the developmental environment for seedlings and cuttings. Incorporating a heating element facilitates the success rate of root germination and propagation and decreases the rooting time significantly. The propagation device of the present concept is not intended to house a plant for a long duration of time and is merely a temporary housing until the plant has visible root development and can be moved to a more permanent container for continued growth.

### BRIEF DESCRIPTION OF THE DRAWING

The object, advantages, and features of this concept will be more readily understood from the following detailed description, when read in conjunction with the accompanying drawing in which:

FIG. 1 is a side view of the device embodiment of the present invention;

FIG. 2 is a top view of the dome of the device of FIG. 1;

FIG. 3 is a top view of the transparent propagation tray of the device of FIG. 1; and

FIG. 4 is a top view of the catch tray of the device of FIG. 1.

### DETAILED DESCRIPTION OF THE EMBODIMENTS OF THE INVENTION

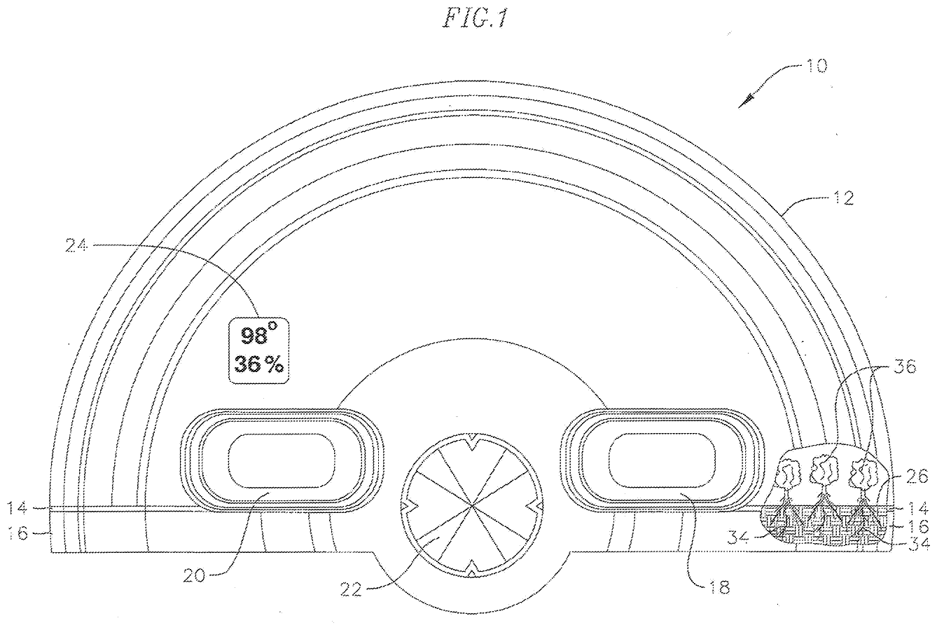

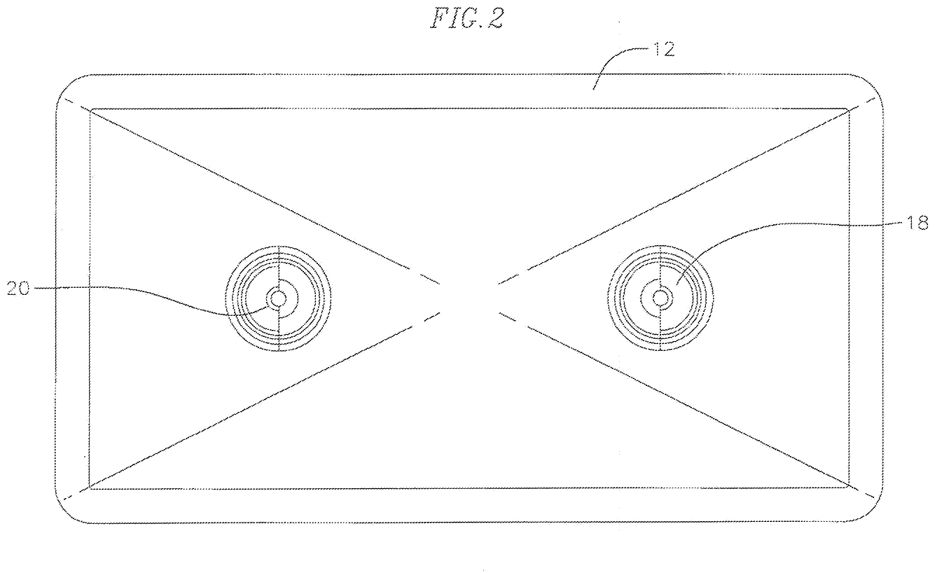

Referring to FIGS. 1-4, an apparatus 10 for the germination and propagation of plants comprises transparent dome 12 positioned on top of transparent propagation tray 14, which are both positioned on opaque catch tray 16. As also can be seen in FIG. 2, dome 12 is transparent and is preferably made from a plastic, such as polyvinyl chloride (PVC), and includes one or more vents 18, 20 which regulate humidity inside the dome within the structure. The overall shape of dome 12 is generally hemispherical or semi-cylindrical, having a generally rectangular perimeter. However, the size and dimensions can be changed depending upon the particular plants or the number of plants being propagated. As mentioned, the dome is preferably made from a durable transparent plastic, such as PVC, wherein vents 18, 20 can be in either an open or closed position to regulate airflow to reduce moisture loss to seedlings and plant cuttings contained within the device. For example, the dome can be seven inches tall and approximately 10.25 inches wide by 20.25 inches long. Typically the dome would be manufactured through plastic injection molding processes. Although the dome is commonly made of a polymer such as PVC, other plastic materials could also be incorporated. To adjust the flexibility or rigidity of the dome, the polymer can be mixed with plasticizers such as phthalate esters, which increase the plasticity or fluidity of the material. As seen in FIG. 1, the dome includes locking mechanism 22 in order to keep the assembly together during transport or movement. The external part of the locking mechanism is in the form of a button which allows the dome to be snapped onto both propagation tray 14 and catch tray 16. The locking mechanism enables safe transportation of the device from one location to another without potential damage to the cuttings as a result of the dome inadvertently coming apart from the trays. The locking feature eliminates the use of adhesive masking or packing tape or other traditional methods to keep the units together. The locking button also eliminates adhesive residue. Other types of locking features could also be incorporated into the dome to maintain the device in an assembled condition such as perimeter closures or equivalents thereof.

Propagation dome 12 could also be fitted and adapted with an internal thermometer and hygrometer reader 24 having a digital display that enables the user of the device to monitor and determine both the temperature and humidity levels within the device for optimal growth therein. Incorporating internal thermometer and hygrometer devices eliminates the need to remove the dome to use external temperature and humidity probes which could affect the humidity and temperature conditions within the device when the dome is removed from the trays.

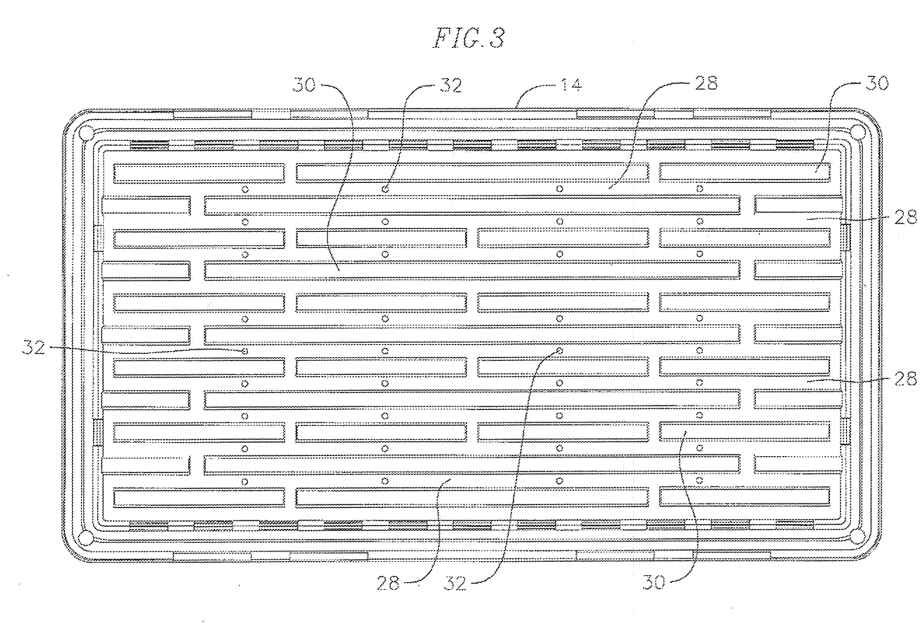

As shown in FIG. 3, propagation tray 14 is a transparent plastic tray, also made from PVC material or other polymers. The transparent propagation tray 14 can also have its durability or rigidity modified by mixing plasticizers with the polymer material. Less plasticizer will be used to allow for a more rigid and thicker component to allow for support of a growing medium 26 (FIG. 1). The transparent propagation tray 14 includes a plurality of channels 28 interconnected in the base of the tray which are separated by a network of raised ridges 30. Water drainage holes 32 are spaced throughout the network of channels 28 to allow for water to pass out of the propagation tray and into catch tray 16. Although multiple geometric configurations of the tray are available depending upon the requirements for this specific plant being propagated, typically the tray will be generally triangular and approximately 10.25 inches wide by 20.25 inches long, corresponding to the dome. The height of the tray can be, for example, approximately three inches.

In order to observe the root development of the plants being propagated the transparent propagation tray can be momentarily, manually lifted from the catch tray to observe root growth 34 of plants 36 (FIG. 1) being propagated by viewing the roots from underneath the propagation tray. Root growth can be viewed with the naked eye and without disturbing the growing medium 26 as the tray is transparent and can be looked through. The user can then determine when the plants are ready to be transferred to the next larger growing container.

The growing medium 26 can be any appropriate growing medium used in propagation of seedlings or other plants but can be, for example, a substance through which roots grow and extract water and nutrients. More commonly, rockwool or mineral wool is utilized which is an inorganic fibrous substance that is produced by steam blasting and cooling molten glass or a similar substance and is used as an insulator and filtering material for seedlings and cuttings. The roots that grow through the growing medium then protrude through and out at which point the plant can be removed from the trays and transplanted into a larger container for more developmental growth.

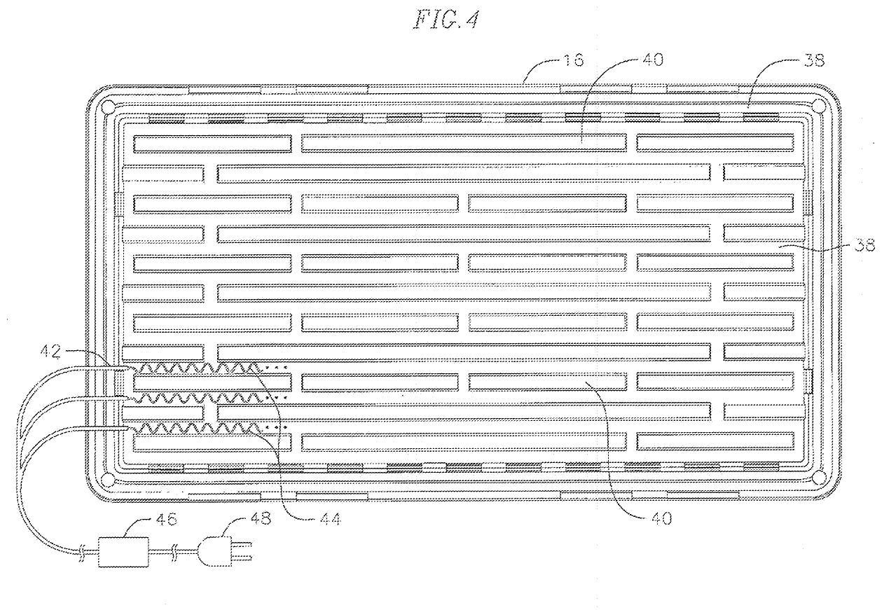

As seen in FIG. 4 catch tray 16 is made of a durable plastic and is completely opaque, preferably black in color, to prevent any light from sun or lamps from coming in contact with the grow medium underside. If roots come in contact with light, they may cease to grow, withering and eventually dying. Thus, the catch tray is designed to fully enclose the propagation tray. The catch tray serves as a housing unit and has the same configuration as the propagation tray so that the propagation tray fits snuggly, or nests, inside the catch tray. This nesting fit results in the upper rims of the two trays being in close proximity or in actual contact. Consequently, the catch tray has a series of channels 38 mirroring those of the propagation tray. The catch tray also is substantially rectangular similar to the propagation tray. The catch tray can incorporate a detachable heating pad which can either be incorporated on the interior in channels 38 or on the exterior of the tray in raised projections 40 for controlling the temperature within the device. The heating element includes insulated rubber-covered coils 44 and includes digital temperature control gauge 46 attached to power cord 48. Considering the heating pad is detachable, the power cord or power source can be left at the site when the device is moved or can be transferred with the device. In plant propagation, heating can be an important element for root development and root growth. The proper temperature is crucial in creating a developmental environment for seedlings and cuttings and facilitates the success rate and decreases the rooting time significantly.

The propagation and germination device of the embodiments of the present invention is a temporary housing for visible root development and is not intended to house a plant for any long duration of time. Consequently, maintaining proper growing conditions and providing the ability to monitor root growth without disturbing the plant are a feature of the apparatus.

Although the present apparatus has been described and illustrated with respect to a preferred embodiment thereof, it is to be understood that changes and modifications can be made therein which are within the full intended scope of the structure as hereinafter claimed.

What is claimed is:

1. A plant propagation and germination apparatus comprising:
a transparent dome;
a transparent propagation tray having a series of channels for the circulation of water within the propagation tray positioned under the dome; and
an opaque catch tray having a series of channels corresponding to the channels of the propagation tray for flush nesting of the transparent propagation tray in the catch tray;
wherein the dome has a locking mechanism to removably, rigidly attach the dome to both of the propagation tray and the catch tray; and
wherein the locking mechanism is provided for removably, snappingly engaging both of the propagation tray and the catch tray.

2. The apparatus of claim 1, wherein the dome has at least one ventilation site that can be in an open or closed position.

3. The apparatus of claim 1, wherein the dome includes a thermometer and a hygrometer.

4. The apparatus of claim 1, wherein the channels are defined by a series of raised ridges spaced within the propagation tray and the catch tray.

5. The apparatus of claim 1, wherein the channels have drain holes.

6. The apparatus of claim 4, wherein the catch tray has a detachable heating pad.

7. The apparatus of claim 6, wherein the heating pad has a plurality of insulated heating coils positioned within the raised ridges.

8. A plant propagation and germination growing device comprising:
a transparent dome;
a transparent propagation tray having a series of channels for the circulation of water within the propagation tray positioned under the dome;
an opaque catch tray for receipt of the transparent dome and the transparent propagation tray in a flush nesting configuration; and
means for removably locking the transparent dome to the transparent propagation tray and to the opaque catch tray together;
wherein the channels are defined by a series of ridges spaced within the propagation tray and the catch tray;
wherein the catch tray has a detachable heating pad; and
wherein the heating pad has a plurality of insulated heating coils individually positioned within the series of raised ridges.

9. The device of claim 8, wherein the dome has two vents positionable in an open or closed condition.

10. The device of claim 8, wherein the means for locking is positioned on the dome for locking engagement with the propagation tray and the catch tray.

11. The device of claim 8, wherein the locking mechanism comprises an external button.

12. The device of claim 8, wherein the dome includes a thermometer and a hygrometer.

13. The device of claim 8, wherein the channels have drain holes.
